(19) United States
(12) Patent Application Publication
(10) Pub. No.: US 2005/0070420 A1
(43) Pub. Date: Mar. 31, 2005

(54) Pressing unit for separating the diecut blanks of a sheet

(75) Inventor: Jean-Pierre Steiner, Crissier (CH)

Correspondence Address: OSTROLENK FABER GERB & SOFFEN, 1180 AVENUE OF THE AMERICAS, NEW YORK, NY, 100368403, US

(73) Assignee: Bobst S.A.

(21) Appl. No.: 10/931,388

(22) Filed: Sep. 1, 2004

(30) Foreign Application Priority Data
Sep. 1, 2003 (CH) 01495/03

(51) Int. Cl. B26F 3/00; B65H 35/00; A47G 29/00

(52) U.S. Cl. 493/472; 225/105; 225/106

(57) ABSTRACT

A pressing unit with a pressure rail interdependent with at least two parallel rods, the rods mounted for axially sliding between two end positions, through a horizontal upper support, via a connecting device. An elastic pull-back spring arranged between the support and the pressure rail likely maintains the rail in its most wide apart position from the horizontal upper support, defined by stops interdependent of the rods. The connecting device comprises a bearing surface against the upper side of the upper support and at least two deformable claws symmetrically arranged with respect to the longitudinal axis of the rod passage. The claws pass through two related passages through the support and the claws each comprise a bearing surface against the lower surface of the support.

### BACKGROUND OF THE INVENTION

The present invention refers to a pressing unit particularly useful for separating diecut blanks of a sheet. The unit comprises a pressure rail interdependent with at least two parallel rods. The rods are mounted slidable between two axial end positions of the rods, through a horizontal upper support, and are mounted to the support via a connecting means. The connecting means comprise elastic means between the support and the pressure rail for likely maintaining the rail in its most wide apart position from the horizontal upper support, determined by interdependent stops of the rods.

At the time of diecutting cardboard blanks from a large sheet, the blanks are separated by narrow strips and connected to the adjacent strips with very thin cardboard nicks between very short diecutting line breaks. Thus, the sheet is delivered on a lower supporting board with blank-shaped apertures. To strip the blanks from the sheet, a pressing unit of the type herein is positioned above the sheet, located where the narrow strips separate the blanks.

The same kind of device is described in U.S. Pat. No. 5,529,565. To relatively free the pressure rail with respect to the sliding rods, the related ends of the pressure rail are swivelingly assembled at the ends of the sliding rods, which enables compensating for the inherent flatness or parallelism faults between the pressing unit and the lower supporting board.

Such a device comprises many parts, leading to a rather expensive manufacturing and assembling solution. Moreover, this alternative has inconvenience of wearing, because the sliding rods are made of steel whereas the pressure rail is made of aluminum. The pressure rail is interconnected by a pin crossing through the rod and the rail. Constantly repeated motion causes the pin to eat into the aluminum rail, increases the hole provided in the rail, generates friction and noise, before giving way. The pressure rail may thus fall into the passage of the gripper bar conveying the cardboard sheets, causing a machine stop and damage which is likely to stop the machine for a more or less long time.

One device described in U.S. Publication No. 2003/0032539 is a pressing unit with rods arranged into connecting means with an angular freedom degree of a plan including the rod axis of the longitudinal axis of the pressure rail. The connecting means of the rods are each fastened with two screws, which means a relatively long assembling process for the set of pressure rails.

### SUMMARY OF THE INVENTION

The aim of the present invention is to meet, at least partly, the abovementioned difficulties.

To this end, the invention relates to a pressing unit particularly for separating the diecut blanks of a sheet.

The connecting means of the pressing unit according to the invention comprise a bearing surface, which bears against the upper side of the upper support, and at least two deformable claws, which are symmetrically arranged with respect to the longitudinal axis of said passage. The claws cross at least two related corresponding passages through the support, and each claw has a bearing surface against the lower surface of the support.

Such a connecting means allow a single and fast fastening, without any sliding rods having to be screwed into the upper support, This enables a significant reduction of the cost of the pressing unit, with an even greater reduction if the connecting means is made up of a plastic material that may be manufactured through an injection process.

Rigid fastening of the rail to the sliding rods ends avoids any wear risk, which might be followed by a rail fall, resulting in damage risks. The fastening is advantageously associated with some freedom for the rods, enabling the rods to adapt the rail position to abovementioned parallelism defects.

The stops interdependent with the sliding rods are preferably nuts screwed on threaded parts of the related rods and a respective connection, each comprising a housing having one size related to the distance between two parallel sides of the nut, so that the nut can enter the housing only at a specific angular or rotational orientation, enabling registering any change in the original position of the nut.

This embodiment easily registers any nut looseness because the sliding rod cannot revert anymore in its original position.

The following specification describes other specific features of the subject matter of the invention that will be more easily understood from an embodiment of said pressing unit, given by way of non-limitative example and illustrated by the accompanying drawings.

### BRIEF DESCRIPTION OF THE DRAWINGS

FIG. 1 is a partial prospective view of an embodiment of the invention without an upper support;

FIG. 2 is a partial raising and sectional view of the embodiment with the upper support;

FIG. 3 is a sectional view along the line III-III of FIG. 2;

FIG. 4 is a same view as FIG. 3 illustrating the sliding rod in its second end position;

FIG. 5 is a top view of FIG. 2.

### DESCRIPTION OF A PREFERRED EMBODIMENT

A pressing unit of the invention comprises a horizontal upper support 1 comprised in this example of a wooden board with apertures 1a for through passage and for travel of sliding rods 2. Only one aperture and one rod 2 are shown here. The rod 2 is mounted slidingly in connecting means 3 comprising four deformable fastening claws 3a which cross through four separate respective openings 1b provided through the upper support 1. Each deformable fastening claw 3a ends at a stop surface 3b extending toward the exterior part of the deformable claw 3a. The stop surface is adjacent a locking surface 3c that is slanted toward the internal side of the deformable claw 3a.

In their fastened position on the supporting board 1, the deformable fastening claws 3a are slightly slanted with respect to their free state. The stop surfaces 3b are meant to be parallel to the supporting board 1 when in the fastened position of the connecting means 3, to ensure good contact between the stop surface and the lower side of the supporting board 1 against which the stop surfaces 3b bear.

The connecting means 3 is preferably an injection molded plastic material part. It can thus be manufactured at low cost. Its fastening requires no tool, but only a single pressure applied toward the bottom after the positioning of the ends of the four claws 3a outside the related apertures 1b of the supporting board 1. This pressure allows the slanted locking surfaces 3c to bend the deformable fastening claws 3a. When the stop surface 3b are at the level of the lower side of the supporting board 1, the deformable claws 3a move these stop surfaces under the supporting board 1, ensuring the fastening of the connecting means 3.

The sliding rod 2 is guided into the connecting means 3 through a rectangular passage 3d, having a small axis length that is obviously related to the diameter of the sliding rod 2. This guides the rod 2 while allowing a slight tilting in a plan comprising the large axis of the rectangular passage 3d.

The lower end of the sliding rod 2 is fastened to a pressure rail 4. One application for the pressure rail is to press on a sheet of diecut blanks during separation of the blanks from the sheet. At least two of the sliding rods 2 are fastened to the ends of the pressure rail 4. The pressure rail 4 is of rectangular section, with one side which includes along its center a longitudinal aperture 4a extending over its whole length. A locking nut 5 is engaged into the channel inside the section of the pressure rail 4, where the nut is kept from rotating.

The lower end of the sliding rod 2 includes a thread 2a intended for receiving the locking nut 5. That end also comprises a second non-threaded section 2b, separated from the threaded section 2a by a groove 2c, in which an elastic ring 6 is engaged. The ring 6 is intended for axially retaining a counter locking device 7 that is held between the elastic ring 6 and a seating surface 2d provided between the non-threaded end 2b and the rest of the rod 2. Thus, when the locking nut 5 is screwed onto the threaded part 2a of the end of the sliding rod 2, the edges of the longitudinal aperture 4a of the pressure section rail 4 are tightened between the nut 5 and the counter locking device 7.

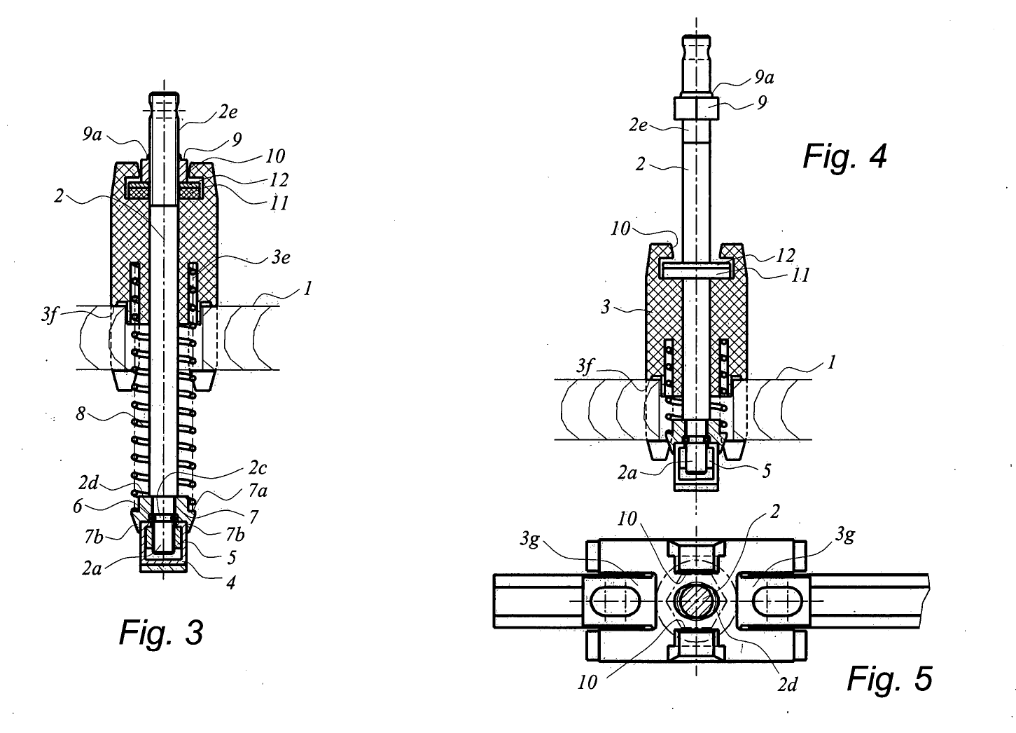

As shown particularly in FIGS. 2 and 3, the counter locking device 7 includes two parallel projections 7b which are in contact with the lateral sides of the pressure rail 4 and prevent the sides from moving aside or apart due to the applied tightening force.

The external surface of this counter locking device 7 includes a seating surface 7a that is intended to serve as a stop for one end of a helical, pull-back, compression return spring 8 mounted around the sliding rod 2. The second end of the spring 8 is engaged in an annular housing 3e provided in the connecting means 3. The pull-back spring 8 acts as elastic means for elastically pressing toward the bottom on the sliding rod 2. Since the pull-back spring 8 is engaged in the annular housing 3e that is concentric with the longitudinal axis of the passage 3d, the pull-back spring 8 also ensures the centering and guiding of the sliding rod 2 with respect to the passage 3d.

The upper part of the sliding rod 2 comprises another thread 2e onto which an axial stop nut 9 is screwed into a position which is adjustable according to the required travel of the sliding rod 2 and thus of the pressure rail 4. The nut 9 in connected with a plastic flange 9a that is intended to increase the friction with the thread 2e to avoid inadequate movement of the stop nut 9 and the length change of the related travel. As noted on FIG. 4, the other end position of the sliding rods 2 is determined by the pressure rail 4 itself.

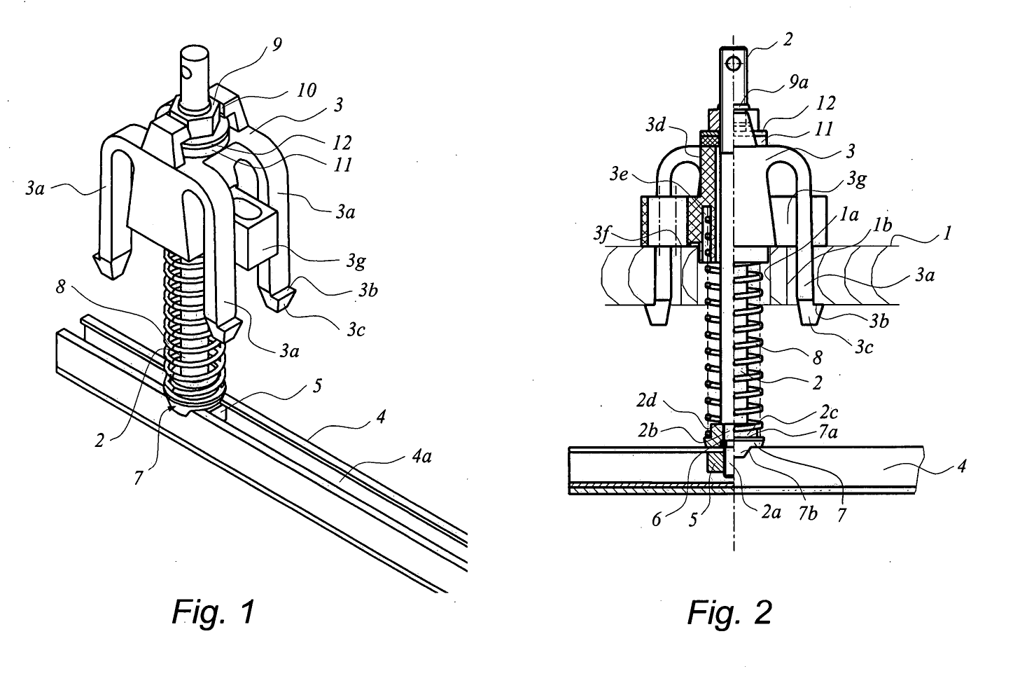

As noted from FIGS. 1, 3 and 4, in the stop position of the apparatus, the nut 9 enters a gauged aperture 10 provided in the upper part of the connecting means 3. The width of the gauged aperture 10 is sized to correspond to the distance between two parallel lateral sides of the stop nut 9, so that the nut can pass through the gauged aperture 10 and reach its bottom stop position only with nut in a determined angular orientation. If the stop nut 9 moves, e.g., rotates in position during its back and forth motion, it could not pass anymore through the gauged aperture 10 and the deviation could be easily registered through an appropriate safety device.

For absorbing the shocks during travel of the sliding rod 2 ends, an elastomer washer 11 covered with a steel washer 12 is arranged on the connecting means 3 around the sliding rod 2.

To compensate for eventual thickness changes of the supporting board 1, a compensating device which is elastically compressible and advantageously provided with an O-ring seal (not shown), may be disposed between the upper side of the supporting board 1 and the bearing surface 3f of the connecting means 3. An annular groove could also be provided in the bearing surface 3f for the O-ring seal housing.

For enabling fastening by screwing the connecting means 3, if such a fastening mode is requested, the connecting means 3 includes two fastening flaps 3g each provided with an aperture aimed for a screw intended to be screwed into the supporting board 1.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. Pressing unit comprising
a pressure rail interdependent with a rod mounted for sliding between two end positions of the rod;
an upper support through which the rod passes, the support having a lower side toward the rail and an opposite upper side;
connecting means between the rod and the support, a rod passage for the rod through the connecting means; the connecting means comprising a bearing surface acting against the upper side of the upper support;
at least two deformable claws symmetrically arranged with respect to the longitudinal axis of the passage, a respective claw passage through the support shaped and placed for passage therethrough of a respective one of the at least two claws and the claws passing through two respective claw passages of the support, each claw passage through the support being shaped and placed for passage therethrough of a respective one of the claws and the passage having a position interdependent with the rod; each claw further comprising a bearing surface acting against the lower surface of the support;
an elastic pull-back device arranged between the support and the pressure rail so as to likely maintain the rail in its most wide apart position from the upper support.

2. Pressing unit according to claim 1, wherein the connecting means includes a bearing surface acting against the upper side of the upper support;
an elastically compressible compensation device connected to the bearing surface and intended for compensating for thickness variations of the upper support.

3. Pressing unit according to claim 1, wherein the connecting means further comprises two flaps each crossed by an aperture for passage of as respective fastening into the upper support.

4. Pressing unit according to claim 1, wherein the connecting means comprise four of the deformable claws symmetrically arranged with respect to the longitudinal axis of the pressure rail and to the longitudinal axis of the passage.

5. Pressing unit according to claim 1, wherein the connecting means are made of a rigid plastic material.

6. Pressing unit according to claim 1, further comprising rigid fasteners between the pressure rail and the rod, the rod being mounted into the related connecting means with a degree of angular freedom for the rod into a plan including the axis of the rod and the longitudinal axis of the rail.

7. Pressing unit according to claim 6, wherein the connecting means and passage is of oblong section having a width related to the diameter of the rod and having a large axis parallel to the longitudinal axis of the pressure rail for the sliding mounting of the rod with an angular freedom degree.

8. Pressing unit according to claim 6, wherein one of the stops of the rod comprises a nut screwed on a threaded section of the rod,
the connecting means comprising an aperture having a size at least related to the distance between two parallel sides of the nut for enabling the nut to enter the aperture only with the nut at a determined angular position, which enables later registering any change of the initial position of the nut.

9. Pressing unit according to one of claim 6, wherein the pressure rail comprises a hollow section with a longitudinal aperture provided along one side, the fastening means between the pressure rail and the rod comprises a nut threaded on a thread of the lower end of the rods and the distance between two parallel sides of the nut is related to an internal space width of the pressure rail, the longitudinal aperture having edges tightened between the nut and a fastening counter device held by a stop interdependent with the rod.

10. Pressing unit according to claim 8, further comprising actuating the nut by means for increasing the friction strength during its rotation onto the threaded part of the sliding rod.

11. Pressing unit according to claim 9, wherein the fastening counter device comprises two parallel projections each acting against one of the lateral sides of the pressure rail.

12. Pressing unit according to claim 1, wherein the connecting means comprise an annular housing concentric with the longitudinal axis of the rod passage having an oblong section, for receiving one end of the elastic pull-back means for centering and the guiding the rod in the passage.

13. Pressure unit according to claim 12, wherein the elastic pull-back means comprises a helical spring.

14. Pressure unit according to claim 1, wherein there are two of the rods, the connecting means and the apertures in the upper support being at locations spaced along the rail.

15. Pressure unit according to claim 1, wherein the rail includes a surface for applying pressure for separating the nut blanks of a sheet.

16. Pressure unit according to claim 1, further comprising two of the rods spaced apart along the rail, and cooperating two of the connecting means and of the passages through the upper support.
